(19) United States
(12) Patent Application Publication
(10) Pub. No.: US 2008/0084590 A1
(43) Pub. Date: Apr. 10, 2008

(54) Flag mounting brackets for motorcycles

(76) Inventor: Richard Mack, Tamarac, FL (US)

Correspondence Address: ROBERT M. DOWNEY, P.A., 6751 N. FEDERAL HWY., SUITE 300, BOCA RATON, FL, 33487, US

(21) Appl. No.: 11/335,131

(22) Filed: Jan. 19, 2006

(51) Int. Cl. H04N 1/04

(52) U.S. Cl. 358/498

(57) ABSTRACT

Bracket assemblies are disclosed for securing one or more flags on a motorcycle. In one embodiment, the bracket assembly mounts to the backrest of a motorcycle and includes opposing plate members which fasten together, with the backrest sandwiched between the plate members. Rubber gaskets and spacers between the plate members prevent damage to the backrest. One or more receptacles, each sized and configured for supported receipt of the lower end of a flagpole therein, are provided on the bracket assembly. The receptacles may either be fixed to the bracket assembly (e.g. by welding, bolts or screws) or integrally formed with the opposing plate members. In another embodiment, the bracket assembly includes a license plate mount, with one or more flagpole receptacles, for attachment to the rear fender of a motorcycle. In yet another embodiment of the invention, individual flagpole receptacles are structured for mounting to either the side or top of the rear fender on a motorcycle.

### BACKGROUND OF THE INVENTION

1. Field of the Invention

The present invention is directed to flagpole supports and, more particularly, to bracket assemblies for securing one or more flags on a motorcycle, wherein the flagpole of each flag is supported in a receptacle that is sized, positioned and arranged to securely hold the flagpole generally upwardly (straight or angled) when the bracket assembly is secured to the motorcycle.

2. Discussion of the Related Art

Flying the flag is a traditional way of showing one's patriotism to their country. Following the terrorist events on Sep. 11, 2001, a strong sense of patriotism has emerged in the United States and sales of American flags have hit record numbers. American citizens throughout the country are proudly flying the American flag on their homes, businesses and vehicles. Of particular relevance to the present invention is the desire to support one or more flags on a motorcycle. In recent years, increasing numbers of motorcycles have been seen flying U.S. flags, which, in most instances, are on a pole. In order to secure the flag on the motorcycle, riders have devised various makeshift methods, most of which involve taping or tying the flagpole to the backrest (sissy bar) or frame structure of the motorcycle. Many of these “homemade” flag mounts are not adapted to withstand the vibration and stresses exerted by wind force when the motorcycle is moving, especially at higher speeds. These methods of attachment are not safe and present the danger of the flagpole slipping down and possibly becoming entangled in the drive train or rear wheel of the motorcycle. Movement or separation of the flagpole from the motorcycle can be extremely dangerous, especially when traveling at higher speeds. Additionally, the various methods presently used for securing flags on motorcycles are unsightly (duct tape, rope, etc.) and may damage the chrome and paint finish. This is a particular concern with more expensive motorcycles such as those manufactured by Harley Davidson.

### OBJECTS AND ADVANTAGES OF THE INVENTION

With the foregoing in mind, it is a primary object of the present invention to provide a selection of bracket assemblies for safely securing one or more flags on a motorcycle without damaging the motorcycle.

It is a further object of the present invention to provide a selection of bracket assemblies for securing one or more flags on a motorcycle, and wherein the bracket assemblies are esthetically appealing.

It is still a further a further object of the present invention to provide a selection of bracket assemblies for securing one or more flags on a motorcycle, and wherein the bracket assemblies are adapted for mounting to existing structure on the motorcycle without requiring alteration of the motorcycle structure and without causing damage to the motorcycle.

It is still a further object of the present invention to provide a selection of bracket assemblies for securing one or more flags on a motorcycle, and wherein the bracket assemblies allow for various mounting alternatives on a large range of motorcycle makes and models.

It is still a further object of the present invention to provide a selection of bracket assemblies for securing one or more flags on a motorcycle, and wherein the bracket assemblies include one or more receptacles for secured, removable receipt of the lower end of a flagpole therein, and wherein the receptacles are structured to safely and securely hold the flagpole in a generally upright manner (either straight or angled) to prominently display one or more flags at an optimal position relative to the motorcycle and rider(s).

These and other objects and advantages of the present invention are more readily apparent with reference to the following detailed description and accompanying drawings.

### SUMMARY OF THE INVENTION

The present invention is directed to bracket assemblies for securing one or more flags on a motorcycle. In one embodiment, the bracket assembly mounts to the backrest of a motorcycle and includes opposing plate members which fasten together, with the backrest sandwiched therebetween. Rubber gaskets and spacers between the plate members prevent damage to the backrest. One or more receptacles, each sized and configured for supported receipt of the lower end of a flagpole therein, are provided on the bracket assembly. The receptacles may either be fixed to the bracket assembly (e.g. by welding, bolts or screws) or integrally formed with the opposing plate members. In another embodiment, the bracket assembly includes a license plate mount, with one or more flagpole receptacles, for attachment to the rear fender of a motorcycle. In yet another embodiment of the invention, individual flagpole receptacles are structured for mounting to either the side or top of the rear fender on a motorcycle.

### BRIEF DESCRIPTION OF THE DRAWINGS

For a fuller understanding of the nature of the present invention, reference should be made to the following detailed description taken in conjunction with the accompanying drawings in which:

FIG. 1 is a side elevational view of the flag mounting bracket assembly, in accordance with a first embodiment thereof, wherein the bracket assembly is provided with a single flagpole receptacle;

FIG. 2 is an elevational view of the rear plate and flagpole receptacle taken along the plane indicated by the arrows 2-2 in FIG. 1;

FIG. 3 is an elevational view of the front plate taken along the plane indicated by the arrows 3-3 in FIG. 1;

FIG. 4 is a side elevational view showing the first preferred embodiment of the present invention, wherein the bracket assembly is provided with two flagpole receptacles;

FIG. 5 is an elevational view of the rear plate and flagpole receptacles taken along the plane of the line indicated by the arrows 5-5 in FIG. 4;

FIG. 6 is an elevational view of the front plate taken along the plane of the line indicated by the arrows 6-6 in FIG. 4;

FIG. 7 is a top plan view of a further embodiment of the present invention;

FIG. 8 is an elevational view of the rear plate member of the embodiment of FIG. 7 taken along the plane of the line indicated by the arrows 8-8 in FIG. 7;

FIG. 9 is an elevational view of the front plate member of the embodiment of FIG. 7 taken along the plane of the line indicated by the arrows 9-9 in FIG. 7;

FIG. 10 is a front elevational view of yet a further embodiment of the present invention, wherein the bracket assembly includes a license plate mount and a single flag pole receptacle;

FIG. 11 is a side elevational view of the embodiment of FIG. 10 showing the bracket assembly mounted to the rear fender of a motorcycle;

FIG. 12 is a rear perspective view showing the bracket assembly including a license plate mount and a pair of flagpole receptacles on opposite sides of the license plate mount;

FIG. 13 is a top plan view of the embodiment of FIG. 12;

FIG. 14 is a front elevational view of the embodiment of FIG. 12;

FIG. 15 is a side elevational view of the embodiment of FIG. 12;

FIG. 16 is a rear elevational view of yet a further embodiment of the bracket assembly of the present invention, wherein a single flagpole receptacle is structured for mounting to the top of the rear fender of a motorcycle;

FIG. 17 is a side elevational view of the embodiment of FIG. 16;

FIG. 18 is a side elevational view of yet a further embodiment of the present invention directed to a single flagpole receptacle adapted for mounting to the side of the rear fender of a motorcycle; and

FIG. 19 is a rear elevational view of the embodiment of FIG. 18.

Like reference numerals refer to like parts throughout the several views of the drawings.

### DETAILED DESCRIPTION OF THE PREFERRED EMBODIMENTS

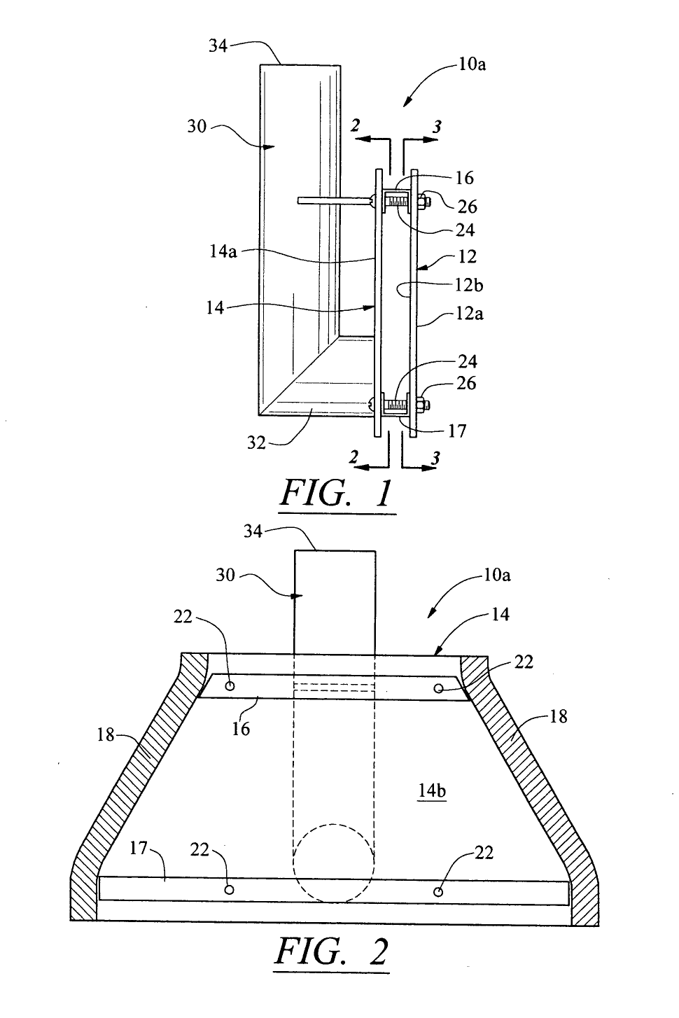

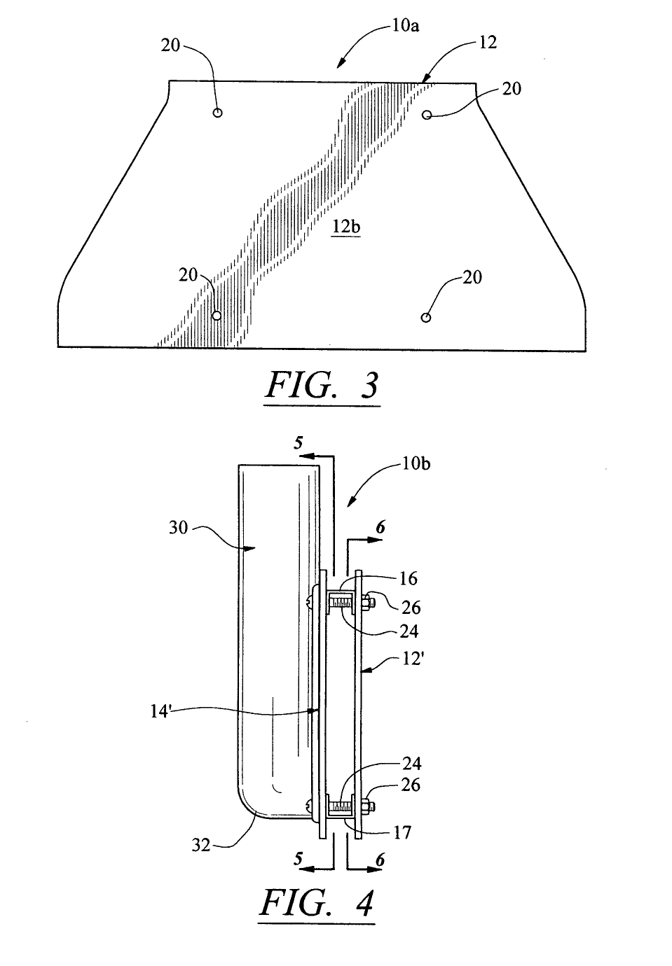

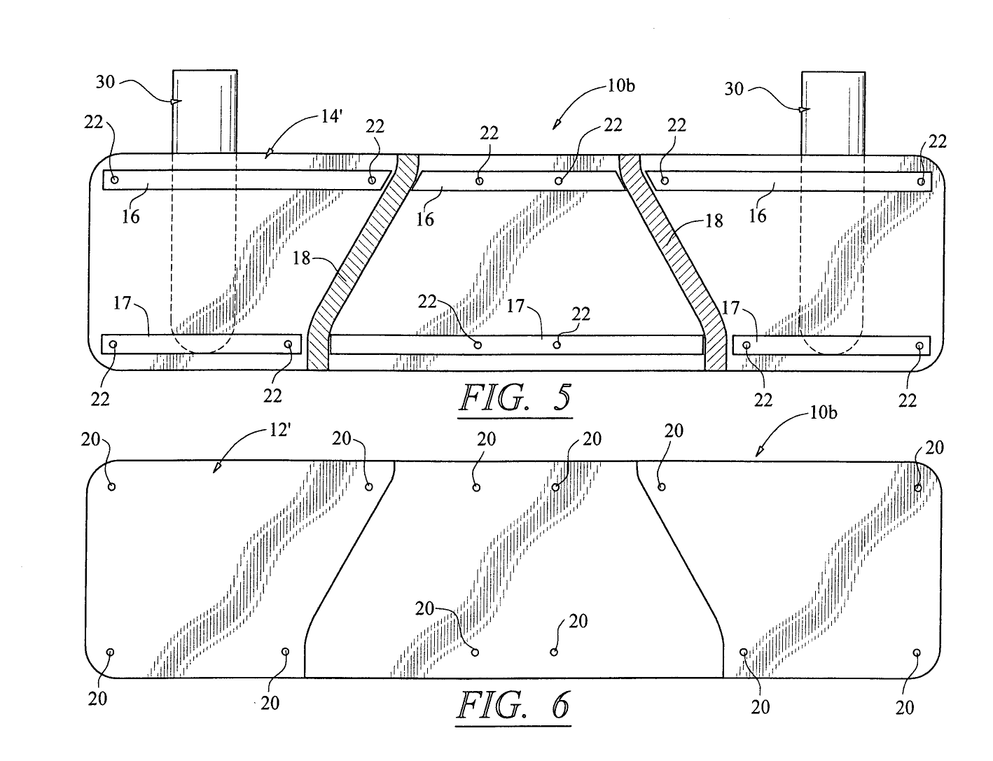

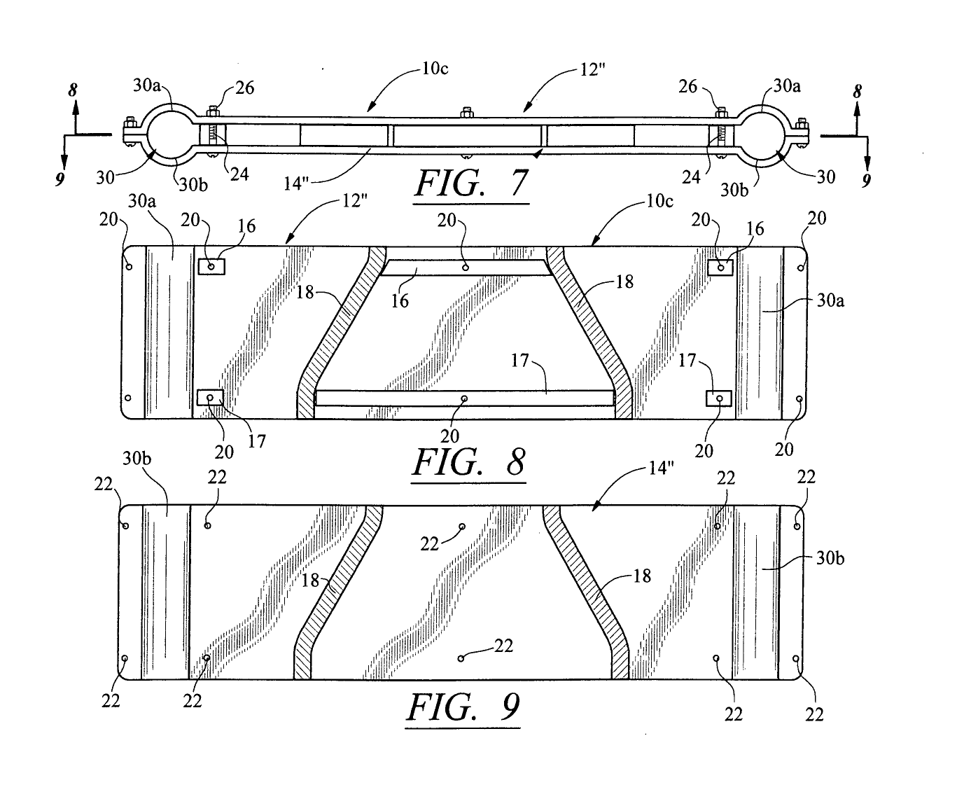

Referring initially to FIGS. 1-3, a first preferred embodiment of the present invention is shown, wherein the bracket assembly is generally indicated as 10A. In this particular embodiment, the bracket assembly is adapted for holding one flag, on a flagpole, when secured to a motorcycle. A variation of this embodiment is shown in FIGS. 4-6, wherein the bracket assembly is generally indicated as 10B. In this particular embodiment, the bracket assembly 10B is adapted to secure two flags on a flagpole when mounted to a motorcycle. FIGS. 7-9 illustrate yet a further variation of the invention, wherein the bracket assembly is generally indicated as 10C. Similar to the embodiment of FIGS. 4-6, the bracket assembly 10C is adapted for securing two flags, on a flagpole, to a motorcycle.

Each of the above identified embodiments of the bracket assembly, namely the bracket assemblies identified as 10A, 10B and 10C, are specifically structured for mounting to the backrest of a motorcycle. More particularly, the bracket assemblies 10A, 10B and 10C, each include a pair of opposing plate members which are adapted to be secured in opposing relation, on opposite sides of the backrest, so that the backrest, and particularly the sissy bar, is disposed in sandwiched relation between the opposing plate members.

Referring again to FIGS. 1-3, the bracket assembly 10A includes a front plate member 12 and a rear plate member 14. In this particular embodiment, the sides of both the front and rear plate members are specifically shaped to follow the contour of the sissy bar which forms the backrest on a motorcycle. The front plate member 12 includes an outer face 12a and inner face 12b. Likewise, the rear plate member 14 includes an outer face 14a and an inner face 14b. The plate members 12, 14 are secured in opposing relation to one another on opposite sides of the sissy bar with the inner faces of each of the plate members disposed in confronting relation to one another and the sissy bar sandwiched therebetween. Upper and lower spacers 16,17 are provided between the plate members to limit movement of the plate members towards one another and against the sissy bar, thereby preventing the plate members from bending and causing damage to the sissy bar. The inner face of either or both of the plate members is provided with gaskets or cushions 18 for mating engagement with the sissy bar, thereby preventing damage to the polished finish of the sissy bar. As seen in FIG. 2, the gaskets 18 are specifically positioned and arranged to follow the contour of the sissy bar, so that the gaskets mate directly against the surfaces of the sissy bar when the opposing plate members are fastened together, on opposite sides of the sissy bar. The front plate member 12 is provided with holes 20 which align with holes 22 on the rear plate member 14. To secure the plate members to the backrest, bolts 24 are fitted through the correspondingly aligned holes on the front and rear plate members. By tightening nuts 26 on the ends of the bolts 24, the forward plate member 14 is urged towards the rear plate member 12, as the front and rear plate members eventually engage the upper lower spacers and the gaskets engage the sissy bar. When fully tightened, as limited by the upper lower spacers, the front and rear plate members are securely fixed to the backrest of the motorcycle.

As seen in FIG. 1, a tubular receptacle 30 is fixed to the outer face 14a of the rear plate member so that the tubular receptacle is arranged vertically. A flange 32 or other member extends between the lower end of the tubular receptacle and the rear plate member and is fixed to the outer face of the rear plate member by welding, bolts, screws or other means. The receptacle 30 is hollow and has an open top end 34 and an inner diameter which is specifically sized for sliding receipt of the lower end portion of a flagpole through the open top end 34. The flagpole may be held within the receptacle by friction or with the use of one or more pins which extend transversely through the receptacle and lower end of the flagpole.

FIGS. 4-6 illustrate a variation of the embodiment of FIGS. 1-3. Specifically, the bracket assembly 10B in FIGS. 4-6 provides for two oppositely positioned receptacles 30, each sized, configured and arranged for removable receipt of the lower end of a flagpole therein. Similar to the embodiment described above, the bracket assembly 10B includes a front plate member 12′ and a rear plate member 14′. Upper and lower spacers 16, 17 are provided between the plate members, along with gaskets 18 for protective engagement with the sissy bar which forms the backrest of the motorcycle. The bracket assembly 10B, and particularly the arrangement of the receptacles thereon, is specifically designed to support two flags extending upwardly on opposite sides of the backrest of the motorcycle.

The bracket assembly 10C in FIGS. 7-9 is yet a further embodiment of the invention and is adapted for mounting to the backrest of a motorcycle. Similar to the embodiments described above, the backrest assembly 10C includes a front plate 12″ and a rear plate 14″ which are fastened together, with bolts and nuts, on opposite sides of the backrest, so that the sissy bar forming the backrest is sandwiched between the plate members. Spacers are provided between the plate members to limit inward movement of the plate members towards one another, as described above in connection with the previous embodiments. Likewise, gaskets are provided on the inner faces of either or both of the plate members for protective engagement with the sissy bar in order to prevent damage to the finished surface of the sissy bar. In this particular embodiment, the front and rear plate members are formed near their ends to provide receptacles for releasable, secured receipt of the lower end of flagpoles therein. Specifically, the front and rear plate members 12″, 14″ are formed to include a partial cylindrical portion 30a, 30b which, in conjunction with the opposing cylindrical portion on the oppositely positioned plate member forms the receptacle 30 for receiving the flagpole therein. When the plate members 12″, 14″ are secured together, as shown in FIG. 7, the flagpole receptacles 30 are formed at opposite ends of the bracket assembly 10C. Similar to the embodiments described above, the receptacles 30 may be sized with an inner diameter for providing a tight friction fit with the flagpole in order to secure and hold the flagpole within the receptacle. Alternatively, the receptacles may be fitted with transverse pin members which extend through the receptacles and the lower end of the flagpole fitted therein. The positioning and arrangement of the receptacles on the bracket assembly 10C supports two flags, on flagpoles, on opposite sides of the backrest of the motorcycle, similar to the bracket assembly 10B described above.

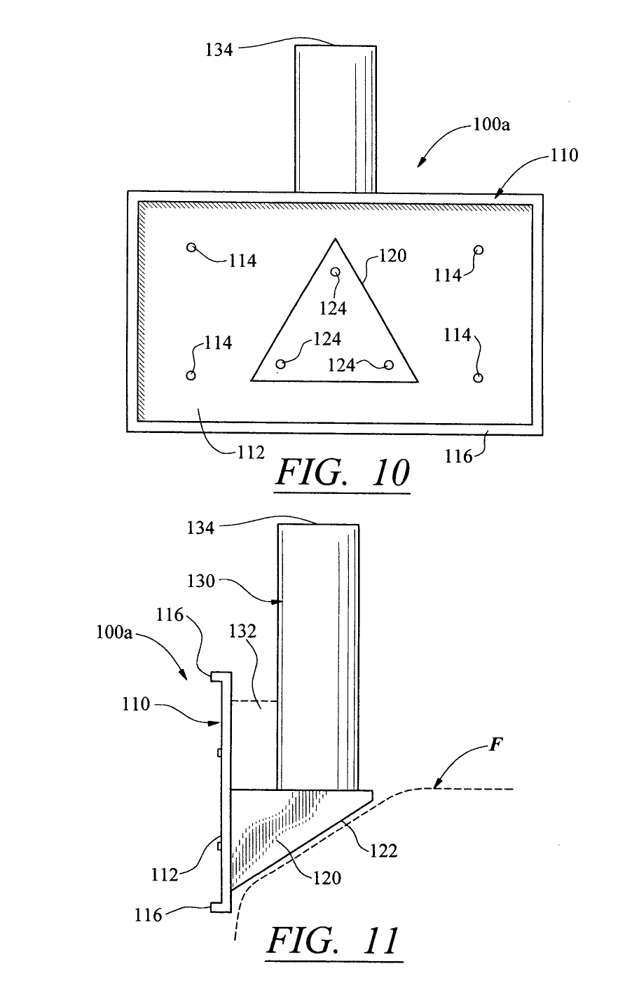

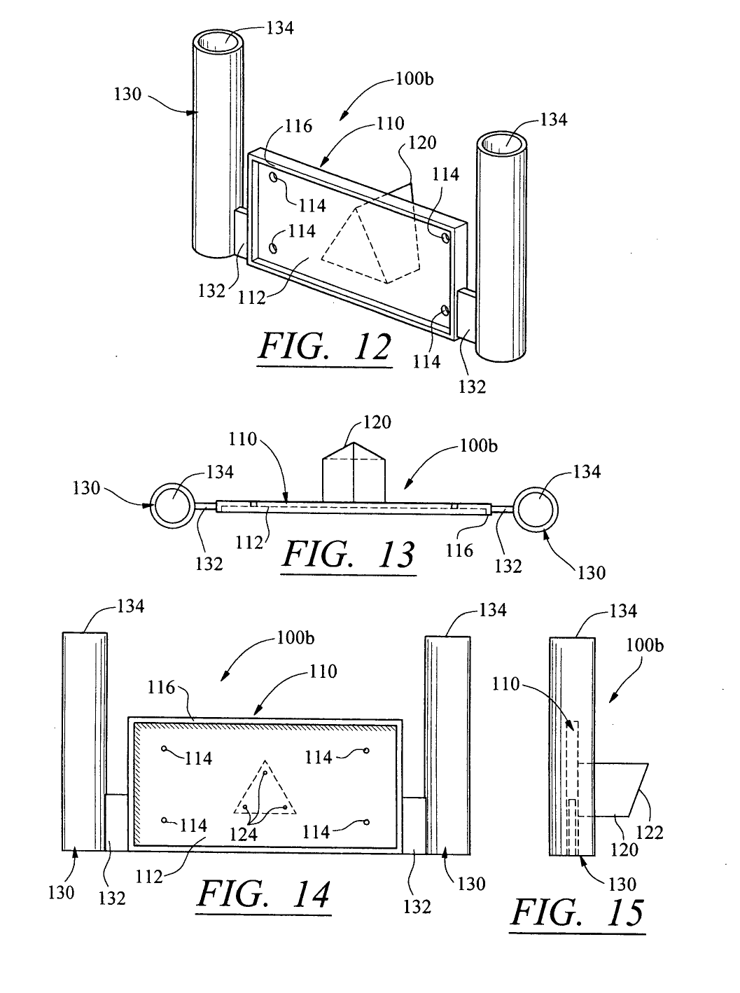

Referring now to FIGS. 10-15, several embodiments of the bracket assembly of the present invention are shown, wherein the bracket assemblies provide for combined mounting of a license plate and holding of one or more flags, on a flagpole, for attachment to the rear fender F of a motorcycle. Specifically, a first embodiment of the combined license plate and flag bracket assembly is shown in FIGS. 10-11 and is generally indicated as 100A. This embodiment is adapted for holding a single flag, on a flagpole. A second embodiment of the combined license plate and flag bracket assembly is shown in FIGS. 12-15, wherein the bracket assembly is generally indicated as 100B. In this embodiment, the bracket assembly 100B is adapted for holding two flags, on a flagpole.

In each of the two embodiments shown in FIGS. 10-15, a license plate mount 110 is provided and includes a flat license plate mount surface 112 sized and configured for mounting receipt of a standard size auto license plate thereon. To facilitate attachment of the license plate to the mount surface 112, threaded screw mounts 114 are provided within the mount surface, near the four corners, as seen in FIGS. 10, 12 and 14. The license plate mount surface 112 is surrounded by a frame 116. A hollow mount channel 120 extends from a rear of the license plate mount surface 112 and, in the various embodiments shown in the drawings, has a generally triangular configuration which is closed on all sides except the front end which is open at the point of joining with the license plate mount surface 112. Thus, the area, as depicted by the triangle in FIGS. 10 and 14 is open on the license plate mount surface 112 and permits access to a rear wall 122 of the mount channel 120 when the license plate is removed from the mount surface 112. Screw holes 124 are provided in the rear wall 122 of the mount channel for attaching the entire bracket assembly 100A or 100B, to the rear fender F of a motorcycle. It should be noted that a triangular arrangement of screw holes are generally standard on the rear fender of motorcycles for universal mounting of a license plate mount bracket. These holes, which are generally universal on motorcycle fenders, align with the holes 124 formed through the rear wall 122 of the mount channel 120.

The bracket assembly 100A in FIGS. 10 and 11 includes a single flagpole receptacle 130 which is fixed to the exterior of the mount channel 120. Additionally, a flange or brace 132 may be welded or otherwise fixedly secured between the license plate mount 110 and the flagpole receptacle 130. Similar to the embodiments described above, in connection with FIGS. 1-9, the flagpole receptacle 130 is provided with an open top end 134 and an inner diameter which is sized and configured for sliding, secure receipt of the lower end of a flagpole therein. In a preferred embodiment, the inner diameter of the flagpole receptacle is one inch.

The bracket assembly 100B shown in FIGS. 12-15 provides for two flagpole receptacles 130, supported on opposite sides of the license plate mount 110. The flagpole receptacles 130 may be fixed by flange members 132 which extend between the flagpole receptacles 130 and the frame 116 of the license plate mount 110, as seen in FIGS. 12-14.

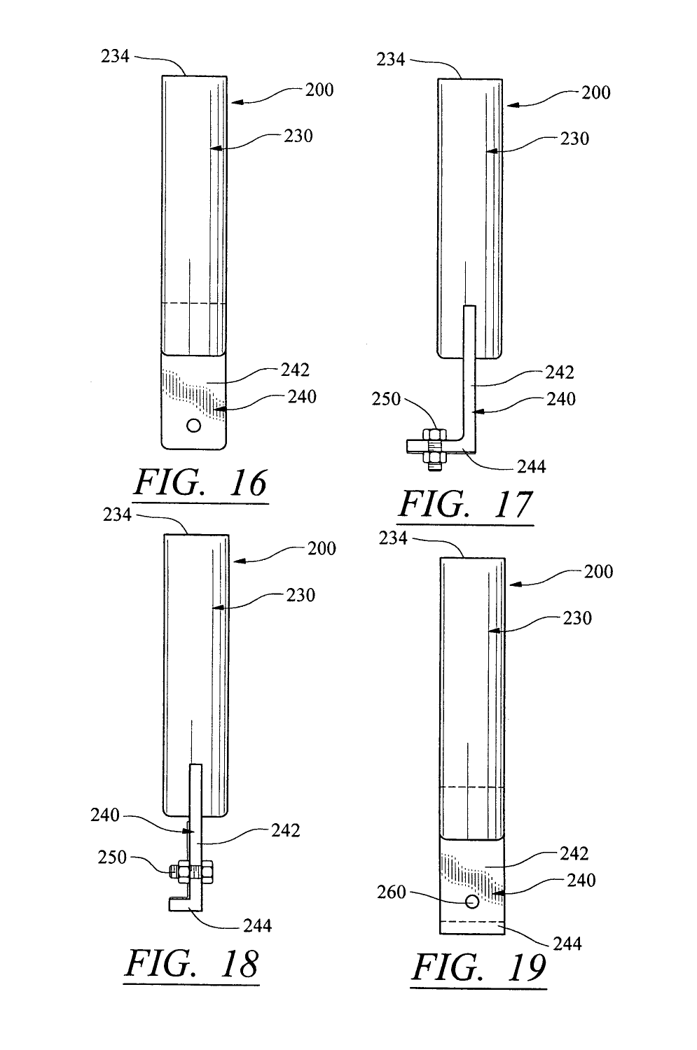

Referring to FIGS. 16-19, a further embodiment of the flagpole mounting bracket assembly is shown and is generally indicated as 200. This particular embodiment provides a single flagpole receptacle 230 which is adapted to mount to either the top of the motorcycle fender or either side of the fender. Similar to the embodiments described above, the flagpole receptacle 230 is provided with an open top 234 and an inner diameter which is sized for removable, secure and sliding receipt of the lower end of a flagpole therein so that when the bracket assembly 200 is mounted to the fender of a motorcycle, the flagpole is supported generally upright, either straight or angled, to optimally position a flag flying from the top end of the flagpole. In a preferred embodiment, the inner diameter of the receptacle 230 is one inch. A mounting brace 240 extends from a lower end of the receptacle 230 and is generally L-shaped to include a vertical portion 242 and a horizontal portion 244. In the instance the bracket assembly 200 is mounted to the top of the motorcycle fender, a hole 246 is provided through the horizontal portion 244 for receipt of a mounting screw 250 therethrough and into the fender. A gasket is placed below the horizontal portion, between the fender and the mounting brace 240 to protect the finish on the motorcycle fender. In the instance the bracket assembly 200 is mounted to either side of the motorcycle fender, a hole 260 is provided in the vertical portion 242 of the L-shaped brace for passage of a mounting screw 250 therethrough. Again, a gasket is provided on the inner facing side of the brace 240 to protect the finish of the fender and other polished surfaces of the motorcycle.

While the instant invention has been shown and described in accordance with a preferred and practical embodiment thereof, it is recognized that departures from the instant disclosure are contemplated within the spirit and scope of the present invention.

What is claim is:

1. A flag mounting device for a motorcycle comprising:
a bracket structured for attachment to the motorcycle; and
at least one flag pole receptacle fixed to said bracket and structured and configured for supported receipt of a lower end of a flagpole therein.

2. The device as recited in claim 1 wherein said bracket includes at least one plate member.

3. The device as recited in claim 2 further comprising:
two of said flagpole receptacles fixed to said at least one plate member.

4. The device as recited in claim 3 further comprising:
a vehicle license plate mount on said at least one plate member.

5. The device as recited in claim 1 wherein said bracket includes a pair of plate members structured and disposed for mounting to the motorcycle and including a first plate member and a second plate member, said first and second plate members being structured for mounting to the motorcycle in spaced opposing relation to one another.

6. The device as recited in claim 5 further comprising:
at least one spacer element between said pair of plate members for discouraging bending of said pair of plate members and damage to the motorcycle.

7. The device as recited in claim 6 further comprising:
at least one gasket between said pair of plate members.

8. The device as recited in claim 5 wherein said at least one flagpole receptacle is fixed to one of said first and second plate members.

9. The device as recited in claim 5 wherein said at least one flagpole receptacle is formed between said pair of plate members when said first and second plate members are mounted in opposing relation to one another.

10. The device as recited in claim 8 further comprising:
two of said flagpole receptacles fixed to one of said first and second plate members.

11. The device as recited in claim 9 further comprising:
two of said flagpole receptacles formed between said pair of plate members.

12. The device as recited in claim 1 wherein said bracket is structured for mounting to a fender of the motorcycle.

13. The device as recited in claim 1 wherein said bracket is structured for mounting to a backrest of the motorcycle.

14. The device as recited in claim 5 wherein said first and second plate members are structured for mounting on opposite sides of a backrest of the motorcycle.

15. A flag mounting device for a motorcycle comprising:
a bracket structured for attachment to the motorcycle and including at least one plate member; and
at least one flag pole receptacle fixed to said bracket and structured and configured for supported receipt of a lower end of a flagpole therein.

16. The device as recited in claim 15 further comprising:
two of said flagpole receptacles fixed to said at least one plate member.

17. The device as recited in claim 16 further comprising:
a vehicle license plate mount on said at least one plate member.

18. The device as recited in claim 15 wherein said bracket includes a pair of plate members structured and disposed for mounting to the motorcycle and including a first plate member and a second plate member, said first and second plate members being structured for mounting to the motorcycle in spaced opposing relation to one another.

19. The device as recited in claim 18 wherein said at least one flagpole receptacle is fixed to one of said first and second plate members.

20. The device as recited in claim 18 wherein said at least one flagpole receptacle is formed between said pair of plate members when said first and second plate members are mounted in opposing relation to one another.
